(19) United States
(12) Patent Application Publication
(10) Pub. No.: US 2023/0409909 A1
(43) Pub. Date: Dec. 21, 2023

(54) DATA ANALYSIS SYSTEM, DATA ANALYSIS METHOD, AND NON-TRANSITORY COMPUTER-READABLE RECORDING MEDIUM

(71) Applicant: KABUSHIKI KAISHA YASKAWA DENKI, Fukuoka (JP)

(72) Inventors: Tsuyoshi YOKOYA, Fukuoka (JP); Ayaka HASHIMOTO, Fukuoka (JP)

(21) Appl. No.: 18/334,897

(22) Filed: Jun. 14, 2023

(30) Foreign Application Priority Data
Jun. 15, 2022 (JP) 2022-096452

(51) Int. Cl. G06N 3/08; G06N 3/063

(52) U.S. Cl. CPC G06N 3/08; G06N 3/063

(57) ABSTRACT

A data analysis system comprises a memory configured to store a data analysis model trained in advance by using training data configured to output an output value indicating whether a target to be analyzed is in a specific state in response to the data analysis model receives input data on the target to be analyzed, the data analysis model including a parameter that includes a random variable; and circuitry configured to input the input data to the data analysis model repeatedly a plurality of times and calculate an estimate indicating a degree of being in the specific state based on a distribution of a plurality of the output values output from the data analysis model for the plurality of times.

### CROSS-REFERENCE TO RELATED APPLICATIONS

This application is based upon and claims the benefit of priority from Japanese Patent Application No. 2022-096452, filed on Jun. 15, 2022. The entire contents of which are incorporated herein by reference.

### BACKGROUND OF DISCLOSURE

### Field of Disclosure

The present disclosure relates to a data analysis system, a data analysis method, and a non-transitory computer-readable recording medium.

### Description of Related Art

International publication number WO 2021/095361 A1 describes a technique, in which data is input to a trained neural network whose weight parameter is defined by a probability distribution and including a stochastic layer that propagates a mean and a variance of the probability distribution of output values to the next stage, to thereby analyze the data.

### SUMMARY

### Solution to Problem

A data analysis system according to an aspect of the present disclosure includes a memory configured to store a data analysis model trained in advance by using training data configured to output an output value indicating whether a target to be analyzed is in a specific state in response to the data analysis model receives input data on the target to be analyzed, the data analysis model including a parameter that includes a random variable; and circuitry configured to input the input data to the data analysis model repeatedly a plurality of times and calculate an estimate indicating a degree of being in the specific state based on a distribution of a plurality of the output values output from the data analysis model for the plurality of times.

### BRIEF DESCRIPTION OF DRAWINGS

FIG. 1 is a diagram illustrating an example of a hardware configuration of a data analysis system.

FIG. 2 is a diagram illustrating an example of functional blocks of a data analysis system.

FIG. 3 is a diagram illustrating an example of processing executed by functional blocks of a data analysis system.

FIG. 4 is a diagram illustrating an example of control data when an abnormality occurs.

FIG. 5 is a diagram illustrating an example of a method of calculating an estimate.

FIG. 6 is a diagram illustrating an example of a training method of data analysis models.

FIG. 7 is a diagram illustrating an example of an analysis results screen displayed by a display control unit.

FIG. 8 is a flowchart illustrating an example of processing executed in a data analysis system.

FIG. 9 is a diagram illustrating an example of functional blocks according to a variation.

FIG. 10 is a diagram illustrating an example of a method of determining a threshold according to Variation 1.

### DESCRIPTION OF EMBODIMENTS

1. Hardware Configuration of Data Analysis System

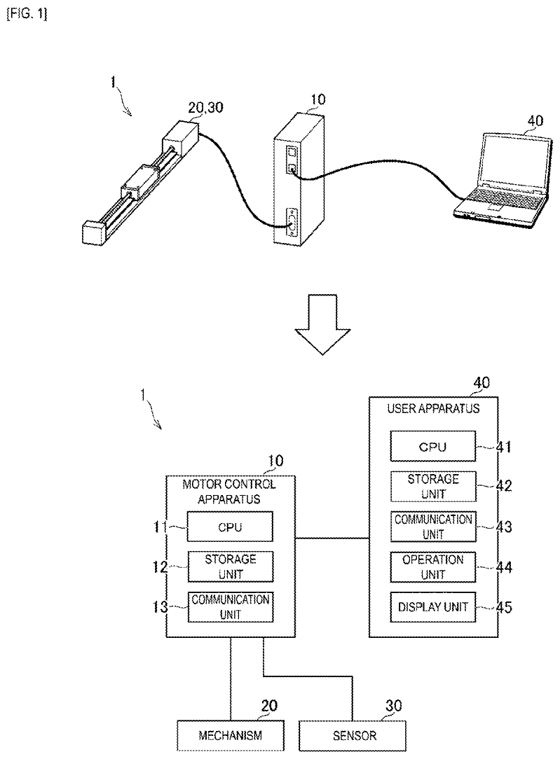

An example of an embodiment of a data analysis system according to the present disclosure will be described. FIG. 1 is a diagram illustrating an example of a hardware configuration of a data analysis system. For example, a data analysis system 1 includes a motor control apparatus 10, a mechanism 20, a sensor 30, and a user apparatus 40.

The motor control apparatus 10 is an apparatus that controls the mechanism 20 of an industrial machine. For example, the motor control apparatus 10 includes a CPU 11, a storage unit 12, and a communication unit 13. The CPU 11 includes at least one processor. The storage unit 12 includes at least one of a volatile memory or a non-volatile memory. The communication unit 13 includes at least one of a communication interface for wired communication or a communication interface for wireless communication.

The mechanism 20 is a machine controlled by the motor control apparatus 10. In the present embodiment, a ball screw will be described as an example of the mechanism 20. However, the mechanism 20 may be of any type and is not limited to a ball screw. For example, the mechanism 20 may be a transmission belt or a gear. The motor control apparatus 10 controls at least one mechanism and may control a plurality of mechanisms 20.

The mechanism 20 includes at least one motor. For example, the mechanism is connected to the motor control apparatus 10 through a power line. In the present embodiment, the mechanism 20 includes a ball screw to which a motor is coupled, a linear guide, and a table. On the table, an object is placed. The object is an object to be subjected to an operation, such as machining or inspection. The object may be referred to as a workpiece. The object is fixed on the table and is moved in conjunction with the table.

The sensor 30 detects information related to control of the mechanism 20. In the present embodiment, a torque sensor will be described as an example of the sensor However, the sensor 30 may be of any type and is not limited to a torque sensor. For example, the sensor 30 may be a motor encoder, a vibration sensor, a motion sensor, an ultrasonic sensor, an infrared sensor, a pressure sensor, a gyro sensor, an acceleration sensor, a temperature sensor, or a vision sensor.

In the example of FIG. 1, the sensor 30 is incorporated into the mechanism 20. However, the sensor 30 may be present outside the mechanism 20. To the motor control apparatus 10, at least one sensor 30 is connected through a communication line or a signal line or a plurality of sensors 30 may be connected. The sensor 30 may be connected to the motor control apparatus 10 through an apparatus such as a hub.

The user apparatus 40 is an apparatus operated by a user. For example, the user apparatus 40 is a personal computer, a tablet terminal, a smartphone, or a server computer. For example, the user apparatus 40 includes a CPU 41, a storage unit 42, a communication unit 43, an operation unit 44, and a display unit 45. The CPU 41, the storage unit 42, and the communication unit 43 may be similar to the CPU 11, the storage unit 12, and the communication unit 13, respectively.

The operation unit 44 is an input device such as a mouse or a keyboard. The display unit 45 is a liquid crystal display or an organic EL display. For example, the user apparatus 40 is connected to the motor control apparatus 10 through a communication line. For example, the user operates the user apparatus 40 and thereby performs various types of operations of the motor control apparatus 10 such as a setting operation or a maintenance operation.

Note that a program to be stored in the motor control apparatus 10 or the user apparatus 40 may be supplied via a network. For example, a program stored in an information storage medium may be supplied to the motor control apparatus 10 or the user apparatus 40 via a reading unit (for example, a memory card slot) that reads a computer-readable information storage medium or an input/output unit (for example, a USB terminal) to connect to an external device.

The hardware configuration of each of the motor control apparatus 10 and the user apparatus 40 is not limited to the example of the present embodiment. Each of the motor control apparatus 10 and the user apparatus 40 may include any type of hardware. For example, an ASIC or an FPGA may be included in the motor control apparatus 10 or the user apparatus 40. The CPUs 11 and 41 are each an example of a configuration referred to as circuitry, but the ASIC or the FPGA may correspond to circuitry.

Apparatuses included in the data analysis system 1 are not limited to the examples of the present embodiment. The data analysis system 1 includes at least one apparatus. For example, the data analysis system 1 may include the motor control apparatus 10 only. In this case, the mechanism 20, the sensor 30, and the user apparatus are present outside the data analysis system 1. For example, the data analysis system 1 may include the user apparatus 40 only. In this case, the motor control apparatus 10, the mechanism 20, and the sensor 30 are present outside the data analysis system 1.

2. Overview of Data Analysis System

In the present embodiment, the motor control apparatus 10 controls the mechanism 20 so that the table is moved to a predetermined position. When some abnormality occurs in the mechanism 20, experienced technicians have hitherto analyzed control data of the motor control apparatus 10. The data analysis system 1 of the present embodiment enables troubleshooting without relying on experiences of technicians, by analyzing control data and estimating abnormal phenomena using a data analysis model that uses machine learning.

The abnormal phenomenon refers to an abnormal phenomenon that occurs as a result of operation of the mechanism 20 when the mechanism 20 is caused to operate while there is an abnormality cause. The abnormal phenomenon may be referred to as an abnormal physical phenomenon. The abnormal phenomenon may be referred to as an occurring incident itself. For example, the abnormal phenomenon is a slipping phenomenon (linear sliding phenomenon) of an object or a table, a slipping phenomenon (rotational sliding phenomenon) of a motor shaft, or a predetermined vibrating phenomenon.

In order to estimate an abnormal phenomenon by using a data analysis model, the data analysis model is to be caused to learn control data at the time of the abnormal phenomenon. However, characteristics exhibited in the control data differ depending on various conditions, such as a mechanism condition related to the mechanism 20 itself, a command condition related to commands for controlling the mechanism 20, and a setting condition related to settings for controlling the mechanism 20. Even if the control data input to a data analysis model is data that is sufficiently used for training at the time of generating the data analysis model and has characteristics with high frequency of occurrence or that is uncertain data having similar characteristics, similar analysis results are obtained, and thus reliability of the analysis results may be unclear.

In view of this, in the present embodiment, control data is repeatedly input to a data analysis model whose parameter includes a random variable a plurality of times, and output values reflecting uncertainty of data analysis are thereby obtained. With this configuration, uncertainty of the data analysis model can be reflected on estimates that are finally calculated, with the result that accuracy of the data analysis is enhanced. Details of the data analysis system 1 will be described below.

3. Function of Data Analysis System

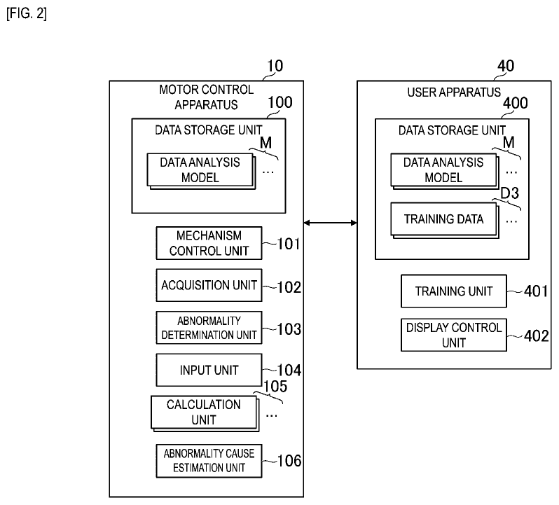

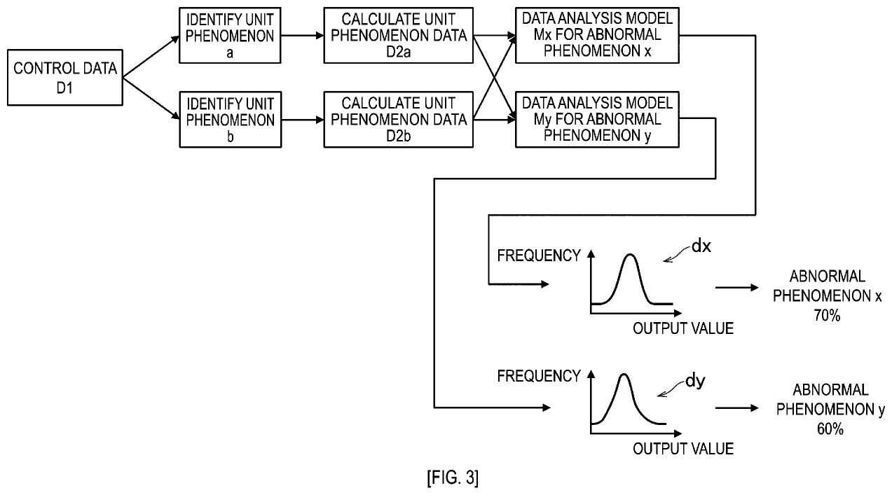

FIG. 2 is a diagram illustrating an example of functional blocks of the data analysis system 1. FIG. 3 is a diagram illustrating an example of processing executed by the functional blocks of the data analysis system 1. With reference to FIG. 3, details of the functional blocks of FIG. 2 will be described below. The data analysis system 1 may at least include a data analysis model M, an input unit 104, and a calculation unit 105, and the functional blocks of the data analysis system 1 are not limited to the example of FIG. 2.

As illustrated in FIG. 3, in the present embodiment, the following are executed, based on control data D1: identification of unit phenomena a and b, calculation of pieces of unit phenomenon data D2a and D2b, data analysis on abnormal phenomena x and y using, respectively, data analysis models Mx and My, creation of distributions dx and dy of output values from, respectively, the data analysis models Mx and My, and calculation of estimates indicating degrees of the abnormal phenomena x and y. Although not illustrated in FIG. 2, an abnormality cause may be estimated from the estimates of the abnormal phenomena x and y, as necessary.

The unit phenomenon refers to an individual phenomenon that is obtained by finely dividing the abnormal phenomenon. The unit phenomenon is defined as a single physical phenomenon, so as not to be dependent upon conditions such as the mechanism condition, the command condition, and the setting condition. Accordingly, even if it is difficult to directly identify the abnormal phenomenon from the control data D1, the unit phenomenon, by contrast, is easily identified. The abnormal phenomenon can be divided into a plurality of unit phenomena. The number of unit phenomena included in the abnormal phenomenon may be any number. For example, the number of unit phenomena included in the abnormal phenomenon may be approximately one to five or may be a number greater than the mentioned number.

For example, the above-described abnormal phenomenon “slipping phenomenon of an object or a table” is divided into a unit phenomenon “sliding phenomenon”, which involves sliding within a movable range on the table, and a unit phenomenon “colliding phenomenon”, which occurs after the sliding within the movable range on the table. The abnormal phenomenon “slipping phenomenon of a motor shaft” is divided into at least one unit phenomenon “sliding phenomenon”, and the unit phenomenon “colliding phenomenon” does not occur after the unit phenomenon “sliding phenomenon”.

In terms of torque, the unit phenomenon “sliding phenomenon” may be referred to as a phenomenon in which torque is reduced below that in a normal case, or a phenomenon in which desired torque cannot be output. In terms of inertia, the unit phenomenon “sliding phenomenon” may be referred to as a phenomenon in which inertia is temporarily reduced during operation of the mechanism 20. The unit phenomenon “colliding phenomenon” may be referred to as generation of spike waveforms. Similarly, for other abnormal phenomena as well, unit phenomena obtained by finely dividing individual abnormal phenomena is defined, so as not to be dependent upon conditions such as the mechanism condition, the command condition, and the setting condition.

The abnormality cause may be a cause of occurrence of the abnormal phenomenon. For example, the abnormality cause is a state in which a phenomenon such as loosening of a screw or damage to a component occurs in the mechanism 20 due to a human error, time-dependent deterioration, or the like and a cause that triggers an abnormality. For example, the abnormality cause includes loosening of a screw, greater acceleration or deceleration than expected, lower friction than expected, presence of backlash in a tapped hole, poor balance of a component such as the table, and poor rigidity of a component such as the table.

3-1. Function of Motor Control Apparatus

For example, the motor control apparatus 10 includes a data storage unit 100, a mechanism control unit 101, an acquisition unit 102, an abnormality determination unit 103, an input unit 104, a plurality of calculation units 105, and an abnormality cause estimation unit 106. The data storage unit 100 is implemented mainly by the storage unit 12. The mechanism control unit 101, the acquisition unit 102, the abnormality determination unit 103, the input unit 104, the plurality of calculation units 105, and the abnormality cause estimation unit 106 are each implemented mainly by the CPU 11.

Data Storage Unit

The data storage unit 100 stores data used for processing executed by the motor control apparatus 10. For example, the data storage unit 100 stores data for controlling the mechanism 20 and data for data analysis.

For example, as the data for controlling the mechanism 20, the data storage unit 100 stores an operation program indicating an operation of the motor control apparatus 10, and an operation parameter referenced by the operation program. The operation program itself may be a publicly known program created using ladder logic or the like. The operation parameter may also be a publicly known operation parameter and may be, for example, a rotating direction, a rotational speed, or the like of the motor of the mechanism 20. The motor control apparatus 10 executes the operation program and refers to the operation parameter as necessary, and thereby controls voltage for the motor included in the mechanism 20.

For example, as the data for data analysis, the data storage unit 100 stores a unit phenomenon identification program, the data analysis model M, an estimate calculation program, and an abnormality cause estimation program. The data storage unit 100 need not necessarily store all of these pieces of data but stores at least the data analysis model M.

The unit phenomenon identification program is a program for identifying the unit phenomenon from the control data D1. In the present embodiment, as an example of a unit phenomenon identification method, an analytic method and a machine learning method to be described below will be described. Thus, the unit phenomenon identification program is a program in which processing for the analytic method is defined, or a program in which processing for the machine learning method is defined. For example, there may be as many unit phenomenon identification programs as the number of unit phenomena to be identified, or a plurality of unit phenomena may be able to be identified with one identification program.

In the present embodiment, processing of calculating unit phenomenon data D2 is also defined in the unit phenomenon identification program. However, the processing may be defined in another program different from the unit phenomenon identification program. For example, as the processing of calculating the unit phenomenon data D2, processing of acquiring magnitudes of waveforms indicated by the control data D1, processing of calculating a mean of the magnitudes, processing of comparing each of the magnitudes and a threshold, or processing of calculating a period in which each of the magnitudes is equal to or greater than the threshold is indicated. Details of such processing will be described below as well.

The data analysis model M is a model trained in advance by using training data so as to output, when receiving the control data D1 regarding the motor control apparatus 10, an output value indicating whether the motor control apparatus 10 is in a specific state. The data analysis model M includes a parameter including a random variable. The motor control apparatus 10 is an example of a target to be analyzed, and the control data D1 is an example of input data. Thus, in a part where description of the motor control apparatus 10 is given, it can be interpreted that this refers to the target to be analyzed, and in a part where description of the control data D1 is given, it can be interpreted that this refers to the input data.

The target to be analyzed is a target to be subjected to analysis. The target to be analyzed is not limited to a tangible thing and may be an intangible thing. For example, the target to be analyzed need not be a physical apparatus and may be a virtual apparatus that operates on a simulator. The target to be analyzed may be an apparatus other than the motor control apparatus 10. For example, the target to be analyzed may be a host controller that manages the motor control apparatus 10, a numerical control apparatus, a programmable logic controller (PLC), a robot controller, a cell controller, an inverter, or a converter. For example, the target to be analyzed is not limited to an apparatus, and may be the mechanism 20, an object, a motor, or a robot.

The input data is data input to the data analysis model M. The input data may be data directly input to the data analysis model M or may be source data for creating the data directly input to the data analysis model M. In the present embodiment, the control data D1 corresponds to the input data, and the unit phenomenon data D2 is directly input to the data analysis model M, and thus the input data is the source data for creating the unit phenomenon data D2 directly input to the data analysis model M. The input data may be referred to as data indirectly input to the data analysis model M.

Note that, instead of the control data D1, the unit phenomenon data D2 may correspond to the input data. In this case, the input data is data directly input to the data analysis model M. The control data D1 may be directly input to the data analysis model M, without particular creating the unit phenomenon data D2. In this case as well, the input data is data directly input to the data analysis model M. At least one piece of input data may be input to the data analysis model M. For example, a plurality of pieces of input data may be input to the data analysis model M. The input data may be data representing some characteristics of the control data D1, instead of characteristics of the unit phenomenon.

In the present embodiment, the data storage unit 100 stores a plurality of data analysis models M that output, respectively, output values indicating whether mutually different abnormal phenomena occur. Thus, the data storage unit 100 stores the data analysis models M for respective abnormal phenomena to be estimated. On the assumption that there are k (k is an integer of 2 or greater) types of abnormal phenomena to be estimated, the data storage unit 100 stores k data analysis models M. The data storage unit 100 stores at least one data analysis model M. If multi-class classification is used, the data storage unit 100 may store only one data analysis model M with which a plurality of abnormal phenomena can be estimated. In addition, for example, if only one abnormal phenomenon is to be estimated, the data storage unit 100 may store only one data analysis model M.

In the example of FIG. 3, trained data analysis models Mx and My are stored in the data storage unit 100. The data analysis model Mx is a model for estimating occurrence of the abnormal phenomenon x. The data analysis model My is a model for estimating occurrence of the abnormal phenomenon y. In the following, when the abnormal phenomena x and y are not to be distinguished from each other, the abnormal phenomena x and y are simply referred to as an abnormal phenomenon, with the alphabets of the suffixes x and y being omitted. Similarly, when the data analysis models Mx and My are not to be distinguished from each other, the data analysis models Mx and My are simply referred to as a data analysis model M.

The present embodiment takes an example of a case in which the data analysis model M is a Bayesian neural network. The Bayesian neural network is a model in which a Bayesian network is replaced with a neural network. In the Bayesian neural network, a random variable is included in a parameter (for example, a weight), and by sampling the parameter based on the random variable, the parameter stochastically changes. Sampling of the parameter may be carried out every time data is input, or parameters for a plurality of times may be sampled and stored in a memory in advance and a parameter to be applied may be changed every time data is input. The stochastically changing parameter is not limited to a weight, and may be another parameter, such as a bias. The Bayesian neural network can output not only estimation results, but also information related to uncertainty based on a distribution of the estimation results.

The parameter stochastically changes in the Bayesian neural network, and thus, even if the same data is input to the Bayesian neural network, output from the Bayesian neural network stochastically changes. For example, when uncertain data (data that has not been used for training) is input to the Bayesian neural network, output values from the Bayesian neural network have a great variation. In other words, the output values do not concentrate in a specific range, but the output values spread out in a wide range.

Note that the data analysis model M may be a model whose output values stochastically change and is not limited to the Bayesian neural network. For example, the data analysis model M may be a Bayesian network which is not a neural network. For example, the data analysis model M may be a model using a hidden Markov model or may be another model referred to as a probability model or a stochastic model.

The estimate calculation program is a program for calculating an estimate based on the output values output from the data analysis model M. In the present embodiment, the estimate calculation program is a program for aggregating the output values output from the data analysis model M, creating the distribution d, and calculating an estimate based on the created distribution d. In the estimate calculation program, processing of the calculation unit 105 to be described below is defined.

The abnormality cause estimation program is a program for estimating an abnormality cause based on the estimate of the abnormal phenomenon. For example, relational data representing a relationship between the estimate of the abnormal phenomenon and the abnormality cause is assumed to be defined in the data storage unit 100 in advance. The relational data may employ any format and may employ, for example, a part or all of a table format, a format of a mathematical expression, a model for machine learning, and a program code. The abnormality cause estimation program refers to the relational data and identifies the abnormality cause associated with the estimate of the abnormal phenomenon, and thereby estimates the abnormality cause.

Note that the data stored in the data storage unit 100 is not limited to the above example. The data storage unit 100 can store any data. For example, the data storage unit 100 may store master data indicating a waveform in a normal case. For example, the data storage unit 100 may store a threshold used for calculating the estimate. For example, the data storage unit 100 may store a history of pieces of the control data D1 acquired in the past.

Mechanism Control Unit

The mechanism control unit 101 controls the motor included in the mechanism 20 based on the operation program stored in the data storage unit 100. As a motor control method itself, various methods can be used. For example, the mechanism control unit 101 executes the operation program stored in the data storage unit 100 and refers to the operation parameter stored in the data storage unit 100, and thereby controls voltage for the motor included in the mechanism 20. The mechanism control unit 101 may control the mechanism 20 based on a detection result of the sensor 30.

Acquisition Unit

The acquisition unit 102 acquires the control data D1 of the motor control apparatus for the motor that drives the mechanism 20 of an industrial machine. The control data D1 is data related to control of the mechanism 20. The present embodiment will describe a case in which numerical values related to the control of the mechanism 20 are exhibited in the control data D1 on a time-series basis. However, the control data D1 may be an instantaneous value indicating an operation at a certain time point. The control data D1 may be referred to as waveform data or trace data. For example, the acquisition unit 102 acquires the control data D1 based on a detection signal of the sensor 30.

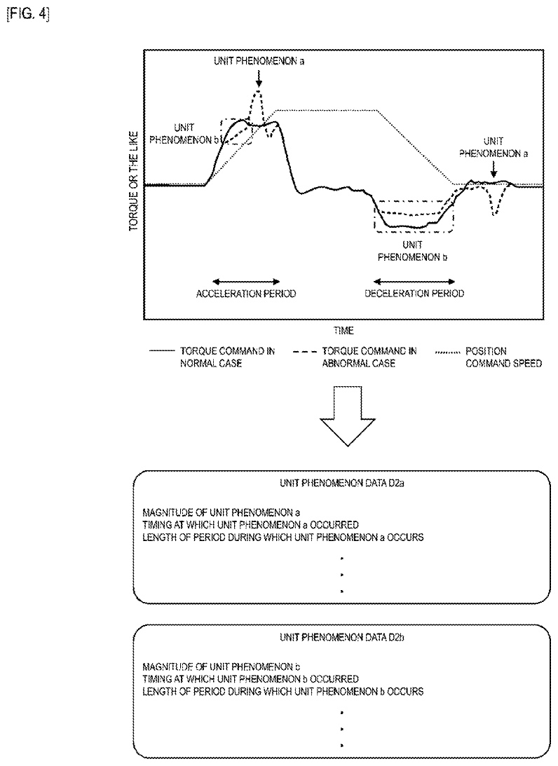

FIG. 4 is a diagram illustrating an example of the control data D1 when an abnormality occurs. The horizontal axis of FIG. 4 is a time axis. The vertical axis of FIG. 4 is an axis indicating a numerical value, such as torque. The solid line of FIG. 4 is a waveform of a torque command in a normal case, which is indicated by the master data. The broken line of FIG. 4 is a waveform of a torque command when an abnormality occurs, which is indicated by the control data D1. The dotted line of FIG. 4 is position command speed. In the example of FIG. 4, an abnormality occurs in each of an acceleration period, which is a period in which the position command speed increases, and a deceleration period, which is a period in which the position command speed reduces. In these periods, there is a large difference in the torque commands between the normal case and the abnormal case.

For example, the acquisition unit 102 measures a physical quantity, such as torque, detected by the sensor 30 on a time-series basis and acquires the control data D1 indicating a change of the physical quantity on a time-series basis. The acquisition unit 102 can acquire any type of control data. The control data acquired by the acquisition unit 102 is not limited to the example of the present embodiment. For example, the acquisition unit 102 can acquire various types of control data, such as estimated disturbance torque, position deviation, feedback speed, or a detection value of a vibration sensor.

Note that the acquisition unit 102 may acquire the control data D1 based on a processing result of the operation program rather than based on the detection signal of the sensor 30. In other words, the control data D1 may be data indicating results of internal processing of the motor control apparatus 10. The control data D1 may employ any format and is not limited to data indicating a waveform. For example, the control data D1 may be data in an image format or a table format.

Abnormality Determination Unit

The abnormality determination unit 103 determines whether an abnormality has occurred based on the control data D1. In the present embodiment, the abnormality determination unit 103 determines whether some abnormality has occurred, and a specific abnormality is estimated by using the data analysis models M. The abnormality determination unit 103 may determine whether an abnormality has occurred based on only one piece of control data D1 or may determine whether an abnormality has occurred based on a plurality of pieces of control data D1 different from each other (for example, two pieces of control data D1, namely a piece of control data D1 indicating the torque command and a piece of control data D1 indicating the detection value of the vibration sensor).

For example, the abnormality determination unit 103 determines whether an abnormality has occurred based on the master data indicating a waveform in a normal case and the latest control data D1 acquired by the acquisition unit 102. For example, when a degree of deviation between the master data and the latest control data D1 is less than a threshold, the abnormality determination unit 103 determines that no abnormality has occurred. When the degree of deviation between the master data and the latest control data D1 is equal to or greater than the threshold, the abnormality determination unit 103 determines that an abnormality has occurred. As the degree of deviation, any indicator can be used, and for example, the Mahalanobis distance may be used.

Note that, as a method itself of determining whether an abnormality has occurred, various methods can be used. For example, aside from the method using the master data, when a degree of deviation between the latest control data D1 and a mean of pieces of control data D1 at a plurality of time points earlier than the time point of the latest control data D1 is equal to or greater than a threshold, the abnormality determination unit 103 may determine that an abnormality has occurred. For example, when there are a certain number or more of time points each at which a numerical value indicated by the latest control data D1 is equal to or greater than a predetermined threshold, the abnormality determination unit 103 may determine that an abnormality has occurred. When an amount of change of the numerical value indicated by the latest control data D1 on a time-series basis is equal to or greater than a threshold, the abnormality determination unit 103 may determine that an abnormality has occurred.

Input Unit

The input unit 104 repeatedly inputs input data to the data analysis model M a plurality of times. Repeatedly inputting the input data a plurality of times refers to repeatedly inputting the input data itself a plurality of times, or repeatedly inputting data created based on the input data a plurality of times. The input unit 104 inputs the same input data to the data analysis model M many times over. The number of times of input of the input data is two times or more and may be any number of times. For example, the number of times of input may be approximately 100 times to 1000 times and may be the number of times equal to or more than that or equal to or less than that.

In the present embodiment, the control data D1 corresponds to the input data, and accordingly the input unit 104 repeatedly inputs, as the input data, the control data D1 to the data analysis model M a plurality of times. Note that the control data D1 being an example of the input data is not directly input to the data analysis model M, and thus repeatedly inputting the unit phenomenon data D2 created based on the control data D1 a plurality of times corresponds to repeatedly inputting the input data a plurality of times.

For example, the input unit 104 identifies the unit phenomenon that has occurred in the mechanism 20 based on the control data D1 and repeatedly inputs the unit phenomenon data D2 related to the unit phenomenon to the data analysis model M a plurality of times. The input unit 104 identifies at least one unit phenomenon based on the unit phenomenon identification program. The present embodiment will describe a case in which the input unit 104 can identify a plurality of unit phenomena based on the identification programs respectively for the plurality of unit phenomena. However, the input unit 104 may identify only one unit phenomenon based on one certain unit phenomenon identification program.

Identifying the unit phenomenon refers to identifying information related to the unit phenomenon. For example, identifying a type of the unit phenomenon corresponds to identifying the unit phenomenon. Identifying the unit phenomenon is not limited to identifying a type of the unit phenomenon and may mean, for example, identifying a timing, a time interval, or a feature of the unit phenomenon. In addition, for example, identifying the number of times of occurrence or frequency of occurrence of the unit phenomenon or comprehensively identifying a plurality of pieces of information related to the unit phenomenon may correspond to identifying the unit phenomenon.

In the present embodiment, when the abnormality determination unit 103 does not determine that an abnormality has occurred, the input unit 104 does not execute processing of identifying the unit phenomenon, whereas when the abnormality determination unit 103 determines that an abnormality has occurred, the input unit 104 executes processing of identifying the unit phenomenon. Note that, also when an abnormality does not occur, the input unit 104 may continue to execute processing of identifying the unit phenomenon. In this case, the motor control apparatus 10 need not include the abnormality determination unit 103.

In the example of FIG. 3, when it is determined that some abnormality has occurred in the mechanism 20, the input unit 104 identifies the unit phenomena a and b based on the control data D1. The input unit 104 calculates the pieces of unit phenomenon data D2a and D2b related to, respectively, the characteristics of the unit phenomena a and b based on the control data D1. In the following, when the unit phenomena a and b are not to be distinguished from each other, the unit phenomena a and b are simply referred to as a unit phenomenon, with the alphabets of the suffixes a and b being omitted. Similarly, when the pieces of unit phenomenon data D2a and D2b are not to be distinguished from each other, the pieces of unit phenomenon data D2a and D2b are simply referred to as a unit phenomenon data D2.

For example, the input unit 104 identifies the unit phenomenon based on the unit phenomenon identification programs and creates the unit phenomenon data D2. In the unit phenomenon identification program, a procedure for processing of identifying the unit phenomenon from the control data D1 is defined. The input unit 104 identifies the unit phenomenon based on a part of a specific section in the control data D1. For example, regarding, in the control data D1, a part of a section from acceleration start to deceleration start and a part of a section after the deceleration start, the input unit 104 determines increase and decrease of torque from the corresponding pieces of normal data by using a threshold and determines each unit phenomenon. Any section is a target to be determined, and only one of these two sections may be a target to be determined. The input unit 104 may identify the unit phenomenon with not only an analytic method of analyzing the control data by using a predetermined analysis method, but also with a machine learning method by using machine learning.

Note that the input unit 104 may identify a timing at which the unit phenomenon occurred. The timing is a timing on the time axis indicated by the control data D1. For example, the timing is a relative time point or period at which or in which the abnormality occurred with respect to a series of repeatedly executed operations. The timing may be referred to as time, a period, or a section. In the example of the control data D1 of FIG. 4, there are timings, such as an acceleration period, a deceleration period, a constant speed period, and a period after stop.

The input unit 104 identifies, on the time axis indicated by the control data D1, a timing of a part that is a basis for identification of the unit phenomenon. With the analytic method, the input unit 104 identifies a timing at which a numerical value or an amount of change thereof that is included in the control data D1 reaches or exceeds a threshold. With the machine learning method, the input unit 104 identifies, as a timing, a part that is the basis for a machine learning model to identify the unit phenomenon, by using a heat map or the like. The input unit 104 may identify timings of all of the unit phenomena or may identify timings of a part of the unit phenomena.

For example, the input unit 104 may identify order of the unit phenomena. The order is order of timings at which the plurality of unit phenomena occurred on the time axis indicated by the control data D1. In other words, the order is temporal anteroposterior relationship. The input unit 104 compares the timings of individual unit phenomena and thereby identifies the order of the plurality of unit phenomena. The input unit 104 may identify order of all of the unit phenomena or may identify only order of a part of the unit phenomena.

For example, the input unit 104 may calculate a time interval between unit phenomena. The time interval is a time length from occurrence of one unit phenomenon to occurrence of its subsequent unit phenomenon on the time axis indicated by the control data D1. The input unit 104 calculates a time interval between timings of individual unit phenomena. The input unit 104 may calculate time intervals between all of the unit phenomena or may calculate only time intervals of a part of the unit phenomena.

For example, the input unit 104 may extract another feature related to a part corresponding to the unit phenomenon in the control data D1. Such another feature is information obtained by quantifying a numerical value or characteristics of change thereof indicated by the control data D1. If the control data D1 is waveform data, characteristics of a shape of a waveform corresponds to the feature. For example, magnitude of a numerical value, width of a waveform, a shape of a waveform, or a combination of these corresponds to the feature. In addition, for example, information such as an amount of change of a numerical value, a mean in a certain period, or a degree of deviation with respect to normal data may correspond to the feature.

The input unit 104 creates the unit phenomenon data D2 based on the processing results described above. Of the control data D1, at least one of the magnitude of a waveform of a part in which each unit phenomenon occurred, a timing at which each unit phenomenon occurred, order of unit phenomena, a time interval between unit phenomena, or another feature is included in the unit phenomenon data D2. The input unit 104 creates pieces of unit phenomenon data D2 for respective unit phenomena. The input unit 104 inputs the control data D1 to the data analysis model M by inputting thereto at least one piece of unit phenomenon data D2 created based on the control data D1.

In the example of FIG. 3, the input unit 104 repeatedly inputs each of the pieces of unit phenomenon data D2a and D2b to the corresponding one of the trained data analysis models Mx and My a plurality of times. The parameter of each of the data analysis models Mx and My stochastically changes, and thus, even if exactly the same pieces of unit phenomenon data D2a and D2b are input, output values from each of the data analysis models Mx and My stochastically change. For example, the output values each indicate a probability of occurrence of the corresponding one of the abnormal phenomena x and y. The output value may be a numerical value within a predetermined range, or such a range need not be determined in particular.

Calculation Unit

The calculation unit 105 calculates an estimate indicating a degree of being in a specific state based on the distribution d of a plurality of output values output from the data analysis model M for each of a plurality of times. In the present embodiment, a plurality of data analysis models M are prepared, and accordingly, the motor control apparatus 10 includes a plurality of calculation units 105 that calculate the estimates indicating the degrees of occurrence of mutually different abnormal phenomena based on the distributions d of each of the plurality of output values, which are obtained by the input unit 104 repeatedly inputting pieces of control data D1 to the plurality of data analysis models M a plurality of times. There may be only a single data analysis model M being prepared, and in this case, there is also only a single calculation unit 105.

The specific state is a state in which a target is to be analyzed. In the present embodiment, whether a specific abnormal phenomenon has occurred is analyzed, and thus takes an example of a case where a state in which the specific abnormal phenomenon has occurred corresponds to the specific state. Thus, in a part where description of the specific abnormal phenomenon is given, it can be interpreted that this refers to the specific state. The calculation unit 105 calculates, as the specific state, an estimate indicating a degree of occurrence of the specific abnormal phenomenon.

Note that the specific state may be another state different from the specific abnormal phenomenon. The specific state is not limited to the specific abnormal phenomenon. For example, the specific state may be a state slightly different from a normal state, not to the extent of being considered abnormal. In other words, the specific state may be a state to be noted, in which an abnormality may occur. For example, when an analysis is carried out by using the data analysis model M regarding in how ideal a state control of the mechanism 20 is handled, the specific state may be the ideal state.

A degree of being in the specific state refers to the extent to which a state is the specific state. The degree may be referred to as probability that a state is the specific state, likelihood that a state is estimated to be the specific state, or likeness to the specific state. The estimate is an indicator indicating how high the degree is. The present embodiment will describe a case in which the estimate is expressed by means of probability. However, the estimate may be expressed by means of a numerical value, a character, or other symbol, other than the probability.

The present embodiment takes an example of a case in which a higher estimate indicates a higher degree of being in the specific state. However, a relationship between the estimate and the degree of being in the specific state is not limited to the example of the present embodiment. For example, a lower estimate may indicate a higher degree of being in the specific state, in a manner opposite to the example of the present embodiment. The estimate and the degree of being in the specific state have a certain correlation. For example, the calculation unit 105 calculates the estimate based on the distribution d and the estimate calculation program.

In the example of FIG. 3, the calculation unit 105 aggregates the output values from each of the data analysis models Mx and My, and thereby acquires the distributions dx and dy. The vertical axis of each of the distributions dx and dy of FIG. 3 indicates frequency (number of times). The horizontal axis of each of the distributions dx and dy of FIG. 3 indicates the output value. The calculation unit 105 calculates the estimates indicating degrees of the abnormal phenomena x and y based on the corresponding distributions dx and dy. In the following, when the distributions dx and dy are not to be distinguished from each other, the distributions dx and dy are simply referred to as a distribution d, with the alphabets of the suffixes x and y being omitted.

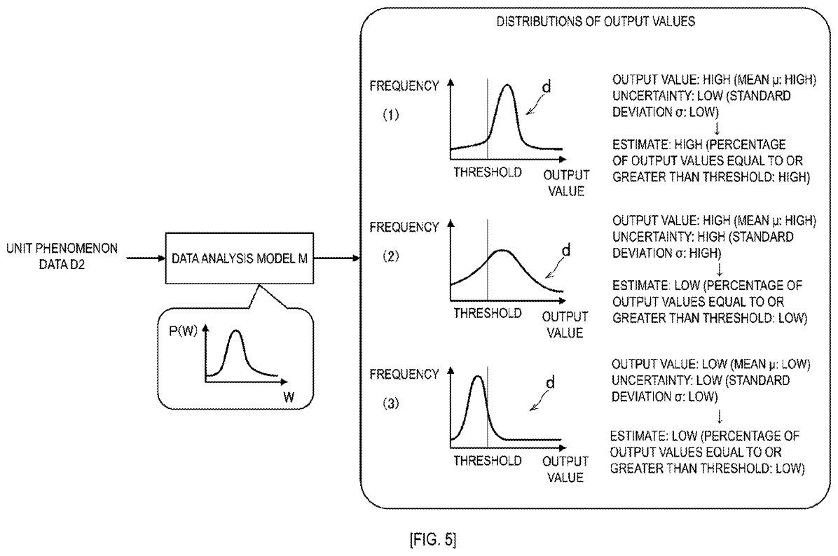

FIG. 5 is a diagram illustrating an example of a method of calculating the estimate. The horizontal axis in the balloon for the data analysis model M in FIG. 5 indicates a parameter W. The vertical axis in the balloon is a probability P(W) of the parameter W. In the present embodiment, the motor control apparatus 10 calculates the percentage of the output values exceeding a threshold in the distribution d as the estimate indicating a degree of an abnormal phenomenon. In FIG. 5, three patterns of (1) to (3) are illustrated.

For example, (1) is a pattern of a case in which the output values are high and uncertainty is low. The estimate of (1) is the highest in FIG. 5. (2) is a pattern of a case in which the output values are high and uncertainty is high. The estimate of (2) is lower than the estimate of (1). (3) is a pattern of a case in which the mean of the output values is low and uncertainty is low. The estimate of (3) is lower than the estimate of (1).

In the present embodiment, the calculation unit 105 calculates the estimate such that the degree of being in the specific state (for example, the probability of the abnormal phenomenon) is lower as the distribution d has a greater variation. A case in which the distribution d has a variation refers to a case in which the frequency of each of the output values is reasonably high over a wide range, rather than a case in which the frequency of only specific output values is extremely high. A case in which the distribution d has a variation may be expressed as a case in which the distribution d spreads out. For example, a high standard deviation, a high variance, or a large coefficient of variation corresponds to a variation in the distribution d. In the present embodiment, an indicator, such as a standard deviation, a variance, or a coefficient of variation, is not calculated, and an indicator with low computational complexity is assumed to be used.

For example, the calculation unit 105 calculates the estimate based on the percentage of the output values equal to or greater than the threshold, or equal to or less than the threshold, in the distribution d. The present embodiment takes an example of a case in which a user designates the threshold. However, the threshold may be determined by using training data D3 of the data analysis model M, as in variations to be described below. The threshold may be a value designated by a manufacturer manufacturing the motor control apparatus 10, instead of being designated by a user. The threshold is assumed to be stored in the data storage unit 100 in advance.

In the present embodiment, the calculation unit 105 refers to the distribution d, and calculates a first total frequency, which is obtained by adding up the frequencies of the output values equal to or greater than the threshold. The calculation unit 105 calculates a second total frequency, which is obtained by adding up the frequencies of all of the output values in the distribution d. The second total frequency is a total number of times the unit phenomenon data D2 is input to the data analysis model M. For example, the calculation unit 105 divides the first total frequency by the second total frequency and thereby calculates the percentage of the output values equal to or greater than the threshold in the distribution d.

In the example of FIG. 3, in the distribution dx, 70% of all of the output values are output values equal to or greater than the threshold. In the distribution dy, 60% of all of the output values are output values equal to or greater than the threshold. The present embodiment will describe a case in which the calculation unit 105 directly acquires the percentage calculated as described above as the estimate. However, the calculation unit 105 may substitute the calculated percentage into a predetermined calculation expression and thereby calculate a final estimate. In addition, for example, the calculation unit 105 may directly acquire the first total frequency as a final estimate.

Note that, when a relationship between the output values and the degree of the abnormal phenomenon is a relationship opposite to that described in the present embodiment (when lower output values indicate a higher degree of the abnormal phenomenon), the calculation unit 105 may refer to the distribution d, add up the frequencies of the output values equal to or less than the threshold, and thereby calculate the first total frequency. The calculation unit 105 may divide the first total frequency by the second total frequency and thereby calculate the percentage of the output values equal to or less than the threshold in the distribution d.

Abnormality Cause Estimation Unit

The abnormality cause estimation unit 106 estimates an abnormality cause based on the abnormality cause estimation program and the estimate of the abnormal phenomenon. A relationship between the estimate of the abnormal phenomenon and the abnormality cause is stored in the data storage unit 100 in advance. For example, the abnormality cause estimation unit 106 executes the abnormality cause estimation program and estimates the abnormality cause associated with the estimate of the abnormal phenomenon. The abnormality cause estimation unit 106 records data indicating the estimated abnormality cause in the data storage unit 100. The data is transmitted to the user apparatus 40.

3-2. Function of User Apparatus

For example, the user apparatus 40 includes a data storage unit 400, a training unit 401, and a display control unit 402. The data storage unit 400 is implemented mainly by the storage unit 42. The training unit 401 and the display control unit 402 are each implemented mainly by the CPU 41.

Data Storage Unit

The data storage unit 400 stores data used for training of the data analysis model M. For example, the data storage unit 400 stores an engineering tool. The engineering tool is a program for assisting operations by a user. The engineering tool enables creation of an operation program to be executed by the motor control apparatus 10, setting of a parameter to be recorded in the motor control apparatus 10, or display of a screen related to an analysis result by the data analysis model M.

For example, the data storage unit 400 stores data analysis models M before training and training data D3 for the data analysis model M. The data analysis model M before training is data analysis models M whose parameter is an initial value. The training data D3 includes a pair of data in the same format as the input data actually input to the data analysis model M and data as a correct answer to be output from the data analysis model M when the data is input.

In the present embodiment, the training data D3 includes a pair of data in the same format as the unit phenomenon data D2 when the specific abnormal phenomenon occurs and data indicating that the abnormal phenomenon has occurred. For example, the user intentionally brings the mechanism 20 or the operation parameter into an abnormal state and thereby creates the training data D3. The training data D3 may be referred to as the control data D1 when the abnormal phenomenon is caused to occur intentionally. The data storage unit 400 stores the pieces of training data D3 for respective abnormal phenomena.

Note that a method of creating the training data D3 is not limited to the example described above. For example, the control data D1 when the abnormal phenomenon unintentionally occurs may be acquired as the training data D3, rather than intentionally causing the abnormal phenomenon to occur. In addition, for example, the training data D3 may be acquired based on control data D1 on a simulator collected when the abnormal phenomenon is caused to occur on the simulator, rather than actually causing the abnormal phenomenon to occur.

Training Unit

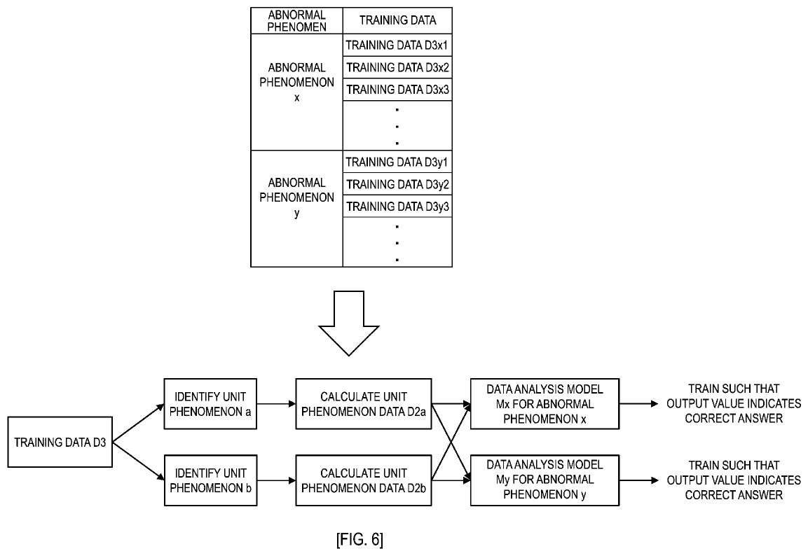

FIG. 6 is a diagram illustrating an example of a training method of the data analysis model M. As in FIG. 6, the training unit 401 executes training of the data analysis model M based on the training data D3. For example, similarly to FIG. 3, the training unit 401 identifies the unit phenomena a and b from the training data D3 and creates the pieces of unit phenomenon data D2a and D2b. The series of above processes is executed in the unit phenomenon identification program. In the data storage unit 400, the unit phenomenon identification program is assumed to be stored. The training unit 401 executes training of each of the data analysis models Mx and My based on the corresponding one of the pieces of unit phenomenon data D2a and D2b created from the training data D3.

As the training method itself of each of the data analysis models Mx and My, various methods used in machine learning can be used. For example, the training unit 401 executes training of the data analysis model M by using the approximate inference method such as the variational inference method, the gradient descent method, or the backpropagation method. When the training unit 401 receives the pieces of unit phenomenon data D2a and D2b created from the training data D3, the training unit 401 adjusts the parameter of each of the data analysis models Mx and My so that the output value indicating occurrence of the abnormal phenomenon is output from each of the data analysis models Mx and My. The training unit 401 records the trained data analysis models Mx and My in the data storage unit 100.

Note that the training data D3 need not be data when the abnormal phenomenon occurs. The training data D3 may be data indicating a normal state. In this case, when the training unit 401 receives the unit phenomenon data D2 created based on the training data D3 indicating a normal state, the training unit 401 adjusts the parameter of the data analysis model M so that the output value indicating no occurrence of the abnormal phenomenon is output from the data analysis model M. The training data D3 indicating a state in a normal case and the training data D3 indicating a state in an abnormal case may be used in training of the data analysis model M.

Display Control Unit

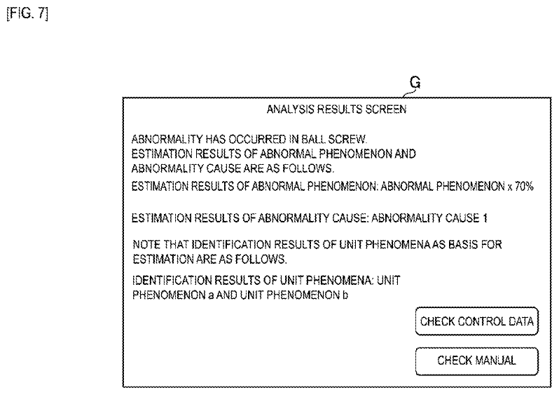

FIG. 7 is a diagram illustrating an example of an analysis results screen displayed by the display control unit 402. For example, the display control unit 402 causes the display unit 45 to display an analysis results screen G indicating analysis results from the data analysis model M based on the engineering tool. For example, the display control unit 402 causes display of the analysis results screen G indicating information related to a unit phenomenon, information related to an abnormal phenomenon, and information related to an abnormality cause. On the analysis results screen G, only a part of these pieces of information may be displayed.

4. Processing Executed in Data Analysis System

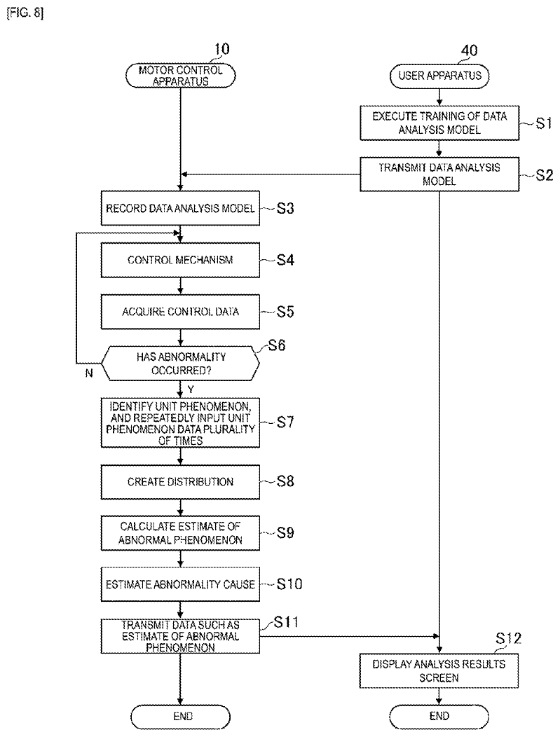

FIG. 8 is a flowchart illustrating an example of processing executed in the data analysis system 1. The processing of FIG. 8 is executed by the CPUs 11 and 41 operating based on the programs stored in, respectively, the storage units 12 and 42.

As in FIG. 8, the user apparatus 40 starts the engineering tool and executes training of the data analysis model M based on the training data D3 (51). The user apparatus 40 transmits the trained data analysis model M to the motor control apparatus 10 (S2). The motor control apparatus 10 records the trained data analysis model M in the storage unit 12 (S3). It is assumed that the motor control apparatus 10 also receives data, such as the unit phenomenon identification program, from the user apparatus 40 and records the data in the storage unit 12.

The motor control apparatus 10 controls the mechanism 20 based on the operation program and the operation parameter stored in the storage unit 12 (S4). The motor control apparatus 10 acquires the latest control data D1 based on a detection signal or the like of the sensor 30 (S5). The motor control apparatus 10 determines whether some abnormality has occurred based on the control data D1 acquired in S5 (S6). When it is not determined that some abnormality has occurred (S6; N), the processing returns to the processing of S4, and control of the mechanism 20 is continued.

When it is determined that some abnormality has occurred (S6; Y), the motor control apparatus 10 identifies the unit phenomenon based on the latest control data D1 and the unit phenomenon identification program and repeatedly inputs the unit phenomenon data D2 to the data analysis model M a plurality of times (S7). The motor control apparatus 10 aggregates the output values output from the data analysis model M in S7 and creates the distribution d (S8).

The motor control apparatus 10 calculates the percentage of the output values equal to or greater than the threshold based on the distribution d created in S8 and the estimate calculation program and thereby calculates the estimate of the abnormal phenomenon (S9). The motor control apparatus 10 estimates the abnormality cause according to the estimate (S10). The motor control apparatus 10 transmits data, such as the estimate of the abnormal phenomenon, to the user apparatus 40 (S11). When the user apparatus 40 receives the data, the user apparatus 40 records the data in the storage unit 42 and causes the display unit 45 to display the analysis results screen G (S12). Then, the processing ends.

The data analysis system 1 of the present embodiment repeatedly inputs the control data D1 to the data analysis model M a plurality of times. The data analysis system 1 calculates the estimate of the abnormal phenomenon based on the distribution d of the plurality of output values output from the data analysis model M for the plurality of times. With this configuration, as compared to a case in which an output value from a model simply including a probability distribution as a parameter is used for the estimate, such an output values can be obtained that reflect uncertainty of the analysis result included in probability distribution in a training process with a plurality of times of input into the data analysis model M. Accordingly, uncertainty of analysis of the data analysis model M can be reflected in the estimate, and therefore accuracy of data analysis is enhanced.

The data analysis system 1 calculates the estimate, such that the degree of the abnormal phenomenon is lower as the distribution d has a greater variation. When certainty of the estimation result of the data analysis model M is low, the distribution d has a variation, even if a mean or a median of the output values is large. The data analysis system 1 can include such a variation in the distribution d in the estimate, and therefore accuracy of data analysis is enhanced.

The data analysis system 1 repeatedly inputs, as the input data, the control data D1 to the data analysis model M a plurality of times and calculates, as the specific state, the estimate indicating the degree of occurrence of the specific abnormal phenomenon. A correlation between the control data D1 for motor control and the abnormal state of a mechanical system has uncertainty, and thus failing to properly take such uncertainty into consideration has hitherto caused difficulties in abnormality estimation. The data analysis system 1 can; however, accurately incorporate such uncertainty and reflect the uncertainty in the estimate. Therefore, accuracy and reliability of analysis can be enhanced.

The data analysis system 1 includes the plurality of data analysis models M that output, respectively, the output values indicating whether mutually different abnormal phenomena occur, and the plurality of calculation units 105 that each calculate the estimate indicating the degree of occurrence of each of the mutually different abnormal phenomena based on the distributions d of each of the plurality of output values, which are obtained by repeatedly inputting the control data D1 to the plurality of data analysis models M a plurality of times. There may be a plurality of types of abnormal phenomena that possibly occur in the mechanism in motor control, and such a plurality of types of abnormal phenomena may be exhibited not only in an exclusive manner but also in a complex manner. Such abnormal phenomena can be represented as the estimate with uncertainty being taken into consideration, and therefore a possibility of identification of abnormal phenomena that occur in actuality can be further enhanced.

The data analysis system 1 identifies the unit phenomenon that has occurred in the mechanism 20 based on the control data D1 and repeatedly inputs the unit phenomenon data D2 related to the unit phenomenon to the data analysis model M a plurality of times. Uncertainty of a correlation between the control data D1 for motor control and the unit phenomenon of the mechanical system is in many cases less uncertain than the abnormal state. Thus, the unit phenomenon that can be identified with a certain degree of accuracy is identified based on the control data D1. Then, by repeatedly inputting the unit phenomenon data D2 to the data analysis model M a plurality of times, accuracy and reliability of analysis can be further enhanced.

The data analysis system 1 calculates the estimate based on the percentage of the output values equal to or greater than the threshold, or equal to or less than the threshold, in the distribution d. An indicator, such as a standard deviation, need not be calculated, and this can thus increase the speed of calculation of the estimate. Even if exactly the same distribution d is used, the estimate varies depending on a method of determining the threshold. Thus, by determining the threshold depending on a target to be analyzed, flexible data analysis can be carried out.

5. Variations

Note that the present disclosure is not limited to the embodiment described above. The present disclosure can be changed as appropriate within the scope not departing from the gist of the present disclosure.

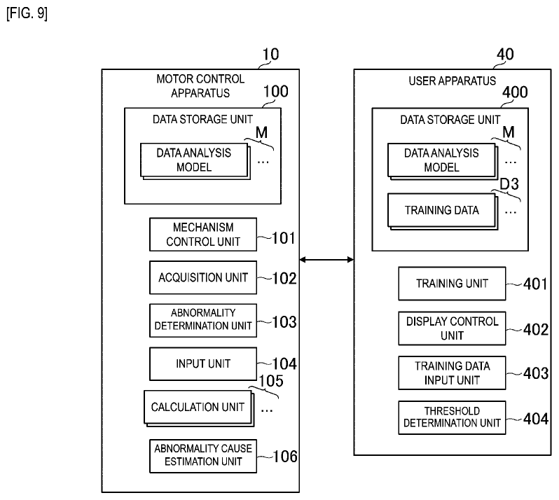

FIG. 9 is a diagram illustrating an example of functional blocks according to a variation. A training data input unit 403 and a threshold determination unit 404 are each implemented by the CPU 41.

Variation 1

For example, the embodiment has described a case in which a user designates the threshold. However, the threshold may be determined based on the trained data analysis model M and the training data D3 used in the training. The data analysis system 1 of Variation 1 includes the training data input unit 403 and the threshold determination unit 404.

The training data input unit 403 repeatedly inputs the training data D3 to the trained data analysis model M a plurality of times. The training data input unit 403 inputs the same training data D3 to the trained data analysis model M many times over. Variation 1 will describe a case in which a plurality of pieces of training data D3 each are repeatedly input to the trained data analysis model M a plurality of times by the training data input unit 403. However, the training data input unit 403 may repeatedly input only one piece of training data D3 to the trained data analysis model M a plurality of times. In other words, not a plurality of pieces but only one piece of training data D3 may be used for determining the threshold.

For example, suppose that the number of pieces of training data D3 is n (n is an integer of 2 or greater), and an individual piece of training data D3 is assumed to be input to the data analysis model M m (m is an integer of 2 or greater) times. In this case, as the input to the trained data analysis model M, n×m times of input occur in total. As described in the embodiment, in the data analysis model M using the Bayesian neural network, the parameter stochastically changes, and thus, even if the same training data D3 is input, the output values that are output from the data analysis model M may not be the same every time but also change. As the output values from the data analysis model M, n×m output values are acquired.

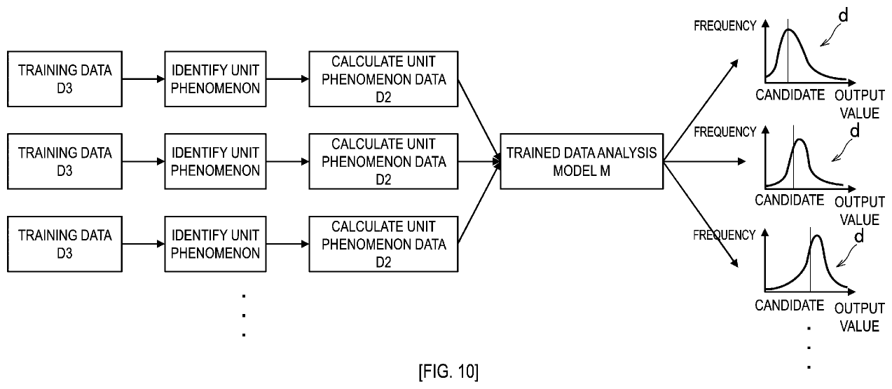

FIG. 10 is a diagram illustrating an example of a method of determining the threshold according to Variation 1. The threshold determination unit 404 determines the threshold based on the distribution d of a plurality of output values output from the trained data analysis model M for a plurality of times. In Variation 1, a plurality of pieces of training data D3 each are repeatedly input to the trained data analysis model M a plurality of times, and thus the distributions d of FIG. 10 are acquired for the respective pieces of training data D3. For example, suppose that the number of pieces of training data D3 is n, and n distributions d are acquired. When an individual piece of training data D3 is input to the data analysis model M m times, a total value of frequencies of the output values in an individual distribution d is m.

For example, the threshold determination unit 404 calculates candidates for the threshold for respective pieces of training data D3 based on the distributions d obtained from the corresponding pieces of training data D3 and determines the largest candidate as the threshold. The candidates are provisional thresholds for determining the final threshold. The candidates can be calculated based on any calculation expression. For example, as the candidate, the threshold determination unit 404 calculates a numerical value obtained by subtracting, from a mean μ of the output values, a numerical value obtained by multiplying a standard deviation a by a predetermined coefficient (for example, 2). The threshold determination unit 404 determines the largest candidate out of n candidates respectively corresponding to n pieces of training data D3 as the final threshold.

Note that the method of determining the threshold is not limited to the example described above. For example, as the candidate, the threshold determination unit 404 may calculate a numerical value obtained by subtracting, from the mean μ, a numerical value obtained by multiplying the standard deviation σ by a coefficient other than 2. For example, the threshold determination unit 404 may calculate the candidate by using only one of the mean μ and the standard deviation σ, instead of using both of the mean μ and the standard deviation σ. For example, the threshold determination unit 404 may calculate the candidate based on a mode, instead of the mean μ.

For example, the threshold determination unit 404 may determine one of the second and subsequent largest candidates as the final threshold, instead of the largest candidate out of the plurality of candidates. The threshold determination unit 404 may determine the smallest candidate out of the plurality of candidates as the final threshold. The threshold determination unit 404 may determine a mean of the plurality of candidates as the final candidate. The threshold determination unit 404 determines the final threshold in some form based on the plurality of candidates. The threshold determined by the threshold determination unit 404 is written in the data storage unit 100 of the motor control apparatus 10.

The data analysis system 1 of Variation 1 repeatedly inputs the training data D3 to the trained data analysis model M a plurality of times and determines the threshold based on the distribution d of a plurality of output values output from the trained data analysis model M for the plurality of times. With this configuration, an optimal threshold according to tendency of the distribution d obtained from the training data D3 can be determined. For example, if a relatively high threshold is set despite the fact that the output values in the distribution d obtained from the training data D3 are generally low, occurrence of the abnormal phenomenon is less easily estimated. However, by setting a threshold according to tendency of the distribution d obtained from the training data D3, optimal data analysis can be carried out while suppressing a situation as above. Conversely, if a relatively low threshold is set despite the fact that the output values in the distribution d obtained from the training data D3 are generally high, occurrence of the abnormal phenomenon may be estimated in any state. However, by setting a threshold according to tendency of the distribution d obtained from the training data D3, optimal data analysis can be carried out while suppressing a situation as above.

The data analysis system 1 repeatedly inputs each of the plurality of pieces of training data D3 to the trained data analysis model M a plurality of times, calculates candidates for the threshold for the respective pieces of training data D3 based on the distributions d obtained from the pieces of training data D3 and determines the largest candidate as the threshold. With this configuration, by determining the largest candidate out of the candidates for the threshold calculated for the respective pieces of training data D3 as the threshold, a criterion, by which a state is considered to be a state of abnormality or the like, can be suppressed from being extremely low. For example, this suppresses a phenomenon, which in fact is not an abnormal phenomenon, from being determined to be an abnormal phenomenon.

Variation 2

For example, the embodiment has described a case in which the calculation unit 105 calculates the percentage of the output values equal to or greater than the threshold, or equal to or less than the threshold, as the estimate. However, the calculation unit 105 may calculate the estimate based on the percentage of the output values within a predetermined range in the distribution d. The predetermined range is a range from a first threshold to a second threshold. The second threshold is assumed to be higher than the first threshold. The first threshold and the second threshold may be designated by a user as in the embodiment or may be a value designated by a manufacturer of the motor control apparatus 10.

In addition, for example, the first threshold and the second threshold may be determined similarly to Variation 1. In this case, the smallest value out of the plurality of candidates described in FIG. 10 may be the first threshold, and the largest value out of the plurality of candidates may be the second threshold. In addition, for example, one of the second and subsequent smallest candidates may be the first threshold, instead of the smallest value out of the plurality of candidates. One of the second and subsequent largest candidates may be the second threshold, instead of the largest value out of the plurality of candidates. The calculation unit 105 of Variation 2 calculates, as the first total frequency, a total value of frequencies of the output values within the predetermined range in the distribution d acquired similarly to the embodiment. The processing of the calculation unit 105 after calculating the first total frequency is similar to that of the embodiment.

The data analysis system 1 of Variation 2 calculates the estimate based on the percentage of the output values within the predetermined range in the distribution d. An indicator, such as a standard deviation, need not be calculated, and this can thus increase the speed of calculation of the estimate. Even if exactly the same distribution d is used, the estimate varies depending on a method of determining the range. Thus, by determining the range depending on a target to be analyzed, flexible data analysis can be carried out. For example, when the data analysis model M is a model that output values depending on a class, by setting the predetermined range such that the specific abnormal phenomenon is extracted, the specific abnormal phenomenon can be extracted from the distribution d of the output values of the data analysis model M.

Variation 3

For example, the embodiment has described a case in which the calculation unit 105 calculates the estimate by using the threshold. However, the calculation unit 105 may calculate an indicator related to a variation in the distribution d and a mean μ of the output values and calculate the estimate based on the indicator and the mean. The indicator is an indicator that can express a degree of a variation in the distribution d. Variation 3 will describe a standard deviation σ as an example of the indicator. However, as the indicator itself, various indicators can be used. For example, the indicator may be a variance. Note that the mean μ is calculated by dividing a numerical value, which is obtained by multiplying the output value by frequency, by all the frequencies.

For example, as the estimate, the calculation unit 105 may calculate a numerical value, which is obtained by multiplying the mean μ and a numerical value obtained by subtracting the standard deviation σ from a predetermined numerical value (for example, 1). The calculation unit 105 calculates the estimate based on a predetermined calculation expression. The mean μ and the standard deviation σ are assumed to be input to the calculation expression. For example, as the estimate, the calculation unit 105 may calculate a numerical value, which is obtained by multiplying the mean μ and a numerical value obtained by subtracting the standard deviation σ from a numerical value other than 1. For example, the calculation unit 105 may multiply at least one of the mean μ or the numerical value obtained by subtracting the standard deviation σ from a predetermined numerical value by a predetermined coefficient.

The data analysis system 1 of Variation 3 calculates the indicator related to the variation in the distribution d and the mean of the output values and calculates the estimate based on the indicator and the mean. By calculating the indicator related to the variation in the distribution d, the estimate more accurately reflecting the variation in the distribution d can be calculated. In addition, the estimate with higher accuracy can be calculated by using not only the indicator but also the mean reflecting tendency of the output values of the entire distribution d.

Other Variations

For example, Variations 1 to 3 may be combined together.

For example, the calculation unit 105 may calculate the estimate based on another calculation method different from both of the calculation method by using the threshold described in the embodiment and the calculation method described in Variation 3. As such another calculation method, the distribution d is used in some form. For example, the calculation unit 105 may calculate the mean μ of the output values in the distribution d directly as the estimate. In this case, the estimate is a value not related to the degree of the variation in the distribution d. For example, the calculation unit 105 may calculate the mode directly as the estimate, instead of the mean μ of the output values in the distribution d.

For example, each of the functions may be implemented in any apparatus in the data analysis system 1. A part or all of the functions described as being implemented in the motor control apparatus 10 may be implemented in the user apparatus 40 or another apparatus. The embodiment has described a case in which the motor control apparatus 10 executes data analysis. However, the function of data analysis may be implemented in the user apparatus 40 or may be implemented in a controller that controls the motor control apparatus 10. In this case, the input unit 104 and the calculation unit 105 are included in the user apparatus 40. The input unit 104 and the calculation unit 105 may be implemented in another apparatus different from the motor control apparatus 10 and the user apparatus 40.

One object of the present disclosure is, for example, to enhance accuracy of data analysis.

Regarding the above examples, the following appendices are provided by way of further illustration.

(Appendix 1) A data analysis system comprising:
a data analysis model trained in advance by using training data configured to output an output value indicating whether a target to be analyzed is in a specific state when the data analysis model receives input data on the target to be analyzed, the data analysis model including a parameter that includes a random variable;
an input unit configured to input the input data to the data analysis model repeatedly a plurality of times; and
a calculation unit configured to calculate an estimate indicating a degree of being in the specific state based on a distribution of a plurality of the output values output from the data analysis model for the plurality of times.
   (Appendix 2) The data analysis system according to claim 1,
wherein the calculation unit calculates the estimate in such a manner that the degree of being in the specific state becomes lower as the distribution varies.
   (Appendix 3) The data analysis system according to claim 2, further comprising
an acquisition unit configured to acquire control data of a motor control apparatus for a motor, the motor being configured to drive a mechanism of an industrial machine,
wherein the input unit inputs, as the input data, the control data to the data analysis model repeatedly a plurality of times, and
the calculation unit calculates, as the specific state, an estimate indicating a degree of occurrence of an abnormal phenomenon specific.
   (Appendix 4) The data analysis system according to claim 3,
wherein the data analysis system includes a plurality of the data analysis models configured to output, respectively, a plurality of the output values indicating whether a plurality of the abnormal phenomena that are mutually different occur, and
a plurality of the calculation units each configured to calculate an estimate indicating a degree of occurrence of each of the plurality of the abnormal phenomena that are mutually different based on a plurality of the distributions of, respectively, a plurality of output values, the plurality of output values being obtained by the input unit inputting the control data to each of the plurality of the data analysis models repeatedly a plurality of times.
   (Appendix 5) The data analysis system according to claim 3 or 4,
wherein the input unit
identifies a unit phenomenon that has occurred in the mechanism based on the control data, and
inputs unit phenomenon data related to the unit phenomenon to the data analysis model repeatedly a plurality of times.
   (Appendix 6) The data analysis system according to any one of claims 2 to 4,
wherein the calculation unit calculates the estimate based on a percentage of a plurality of the output values equal to or greater than a threshold or a plurality of the output values equal to or less than the threshold, in the distribution.
   (Appendix 7) The data analysis system according to claim 6, further comprising:
a training data input unit configured to input the training data to the data analysis model that is trained repeatedly a plurality of times; and
a threshold determination unit configured to determine the threshold based on a distribution of a plurality of the output values output from the data analysis model that is trained for the plurality of times.
   (Appendix 8) The data analysis system according to claim 7,
wherein the training data input unit inputs a plurality of pieces of the training data, respectively, to the data analysis model that is trained repeatedly a plurality of times, and
the threshold determination unit
calculates candidates for the threshold for each of the plurality of pieces of the training data based on the distribution obtained from the plurality of pieces of the training data, and
determines a largest candidate out of the candidates as the threshold.
   (Appendix 9) The data analysis system according to any one of claims 2 to 4,
wherein the calculation unit calculates the estimate based on a percentage of a plurality of the output values within a predetermined range in the distribution.
   (Appendix 10) The data analysis system according to any one of claims 2 to 4,
wherein the calculation unit
calculates an indicator related to a variation in the distribution and a mean of a plurality of the output values; and
calculates the estimate based on the indicator and the mean.
   (Appendix 11) A data analysis method comprising:
inputting input data to a data analysis model repeatedly a plurality of times, the data analysis model being trained in advance by using training data configured to output an output value indicating whether a target to be analyzed is in a specific state when the data analysis model receives the input data on the target to be analyzed, the data analysis model including a parameter that includes a random variable; and
calculating an estimate indicating a degree of being in the specific state based on a distribution of a plurality of the output values output from the data analysis model for the plurality of times.
   (Appendix 12) A program causing a computer to operate as:

an input unit configured to input input data to a data analysis model repeatedly a plurality of times, the data analysis model being trained in advance by using training data configured to output an output value indicating whether a target to be analyzed is in a specific state when the data analysis model receives the input data on the target to be analyzed, wherein the data analysis model including a parameter that includes a random variable; and
a calculation unit configured to calculate an estimate indicating a degree of being in the specific state based on a distribution of a plurality of the output values output from the data analysis model for the plurality of times.

1. A data analysis system comprising:
a memory configured to store a data analysis model trained in advance by using training data configured to output an output value indicating whether a target to be analyzed is in a specific state in response to the data analysis model receives input data on the target to be analyzed, the data analysis model including a parameter that includes a random variable; and
circuitry configured to:
input the input data to the data analysis model repeatedly a plurality of times; and
calculate an estimate indicating a degree of being in the specific state based on a distribution of a plurality of the output values output from the data analysis model for the plurality of times.

2. The data analysis system according to claim 1,
wherein the circuitry is configured to calculate the estimate in such a manner that the degree of being in the specific state becomes lower as the distribution varies.

3. The data analysis system according to claim 2,
wherein the circuitry is configured to:
acquire control data of a motor control apparatus for a motor, the motor being configured to drive a mechanism of an industrial machine,
input, as the input data, the control data to the data analysis model repeatedly a plurality of times, and
calculate, as the specific state, an estimate indicating a degree of occurrence of an abnormal phenomenon specific.

4. The data analysis system according to claim 3, wherein
the memory is configured to store a plurality of the data analysis models configured to output, respectively, a plurality of the output values indicating whether a plurality of the abnormal phenomena that are mutually different occur, and
the circuitry is configured to calculate an estimate indicating a degree of occurrence of each of the plurality of the abnormal phenomena that are mutually different based on a plurality of the distributions of, respectively, a plurality of output values, the plurality of output values being obtained by the input unit inputting the control data to each of the plurality of the data analysis models repeatedly a plurality of times.

5. The data analysis system according to claim 3,
wherein the circuitry is configured to:
identify a unit phenomenon that has occurred in the mechanism based on the control data, and
input unit phenomenon data related to the unit phenomenon to the data analysis model repeatedly a plurality of times.

6. The data analysis system according to claim 4,
wherein the circuitry is configured to:
identify a unit phenomenon that has occurred in the mechanism based on the control data, and
input unit phenomenon data related to the unit phenomenon to the data analysis model repeatedly a plurality of times.

7. The data analysis system according to claim 2,
wherein the circuitry is configured to calculate the estimate based on a percentage of a plurality of the output values equal to or greater than a threshold or a plurality of the output values equal to or less than the threshold, in the distribution.

8. The data analysis system according to claim 3,
wherein the circuitry is configured to calculate the estimate based on a percentage of a plurality of the output values equal to or greater than a threshold or a plurality of the output values equal to or less than the threshold, in the distribution.

9. The data analysis system according to claim 4,
wherein the circuitry is configured to calculate the estimate based on a percentage of a plurality of the output values equal to or greater than a threshold or a plurality of the output values equal to or less than the threshold, in the distribution.

10. The data analysis system according to claim 7, wherein the circuitry is configured to:
input the training data to the data analysis model that is trained repeatedly a plurality of times; and
determine the threshold based on a distribution of a plurality of the output values output from the data analysis model that is trained for the plurality of times.

11. The data analysis system according to claim 8, wherein the circuitry is configured to:
input the training data to the data analysis model that is trained repeatedly a plurality of times; and
determine the threshold based on a distribution of a plurality of the output values output from the data analysis model that is trained for the plurality of times.

12. The data analysis system according to claim 9, wherein the circuitry is configured to:
input the training data to the data analysis model that is trained repeatedly a plurality of times; and
determine the threshold based on a distribution of a plurality of the output values output from the data analysis model that is trained for the plurality of times.

13. The data analysis system according to claim 10, wherein the circuitry is configured to:
input a plurality of pieces of the training data, respectively, to the data analysis model that is trained repeatedly a plurality of times,
calculate candidates for the threshold for each of the plurality of pieces of the training data based on the distribution obtained from the plurality of pieces of the training data, and
determine a largest candidate out of the candidates as the threshold.

14. The data analysis system according to claim 11, wherein the circuitry is configured to
input a plurality of pieces of the training data, respectively, to the data analysis model that is trained repeatedly a plurality of times,
calculate candidates for the threshold for each of the plurality of pieces of the training data based on the distribution obtained from the plurality of pieces of the training data, and
determine a largest candidate out of the candidates as the threshold.

15. The data analysis system according to claim 12, wherein the circuitry is configured to:
Input a plurality of pieces of the training data, respectively, to the data analysis model that is trained repeatedly a plurality of times,
calculate candidates for the threshold for each of the plurality of pieces of the training data based on the distribution obtained from the plurality of pieces of the training data, and
determine a largest candidate out of the candidates as the threshold.

16. The data analysis system according to claim 1,
wherein the circuitry is configured to calculate the estimate based on a percentage of a plurality of the output values within a predetermined range in the distribution.

17. The data analysis system according to claim 1,
wherein the circuitry is configured to:
calculate an indicator related to a variation in the distribution and a mean of a plurality of the output values; and
calculate the estimate based on the indicator and the mean.

18. The data analysis system according to claim 1,
wherein the circuitry is configured to calculate, as the estimate, a value indicating a probability that a specific abnormal phenomenon has occurred in the target to be analyzed based on a percentage of a plurality of the output values equal to or greater than a threshold or a plurality of the output values equal to or less than the threshold, in the distribution.

19. A data analysis method comprising:
inputting input data to a data analysis model repeatedly a plurality of times, the data analysis model being trained in advance by using training data configured to output an output value indicating whether a target to be analyzed is in a specific state in response to the data analysis model receives the input data on the target to be analyzed, the data analysis model including a parameter that includes a random variable; and
calculating an estimate indicating a degree of being in the specific state based on a distribution of a plurality of the output values output from the data analysis model for the plurality of times.

20. A non-transitory computer-readable recording medium containing a program for causing circuitry to implement processing, the processing comprising:
inputting input data to a data analysis model repeatedly a plurality of times, the data analysis model being trained in advance by using training data configured to output an output value indicating whether a target to be analyzed is in a specific state in response to the data analysis model receives the input data on the target to be analyzed, the data analysis model including a parameter that includes a random variable; and
calculating an estimate indicating a degree of being in the specific state based on a distribution of a plurality of the output values output from the data analysis model for the plurality of times.
